(19) United States
(12) Patent Application Publication
(10) Pub. No.: US 2003/0072210 A1
(43) Pub. Date: Apr. 17, 2003

(54) Support arm for a blade-holding plate used in mixers for concrete, mortar and similar materials

(75) Inventor: Paolo Galletti, Perugia (IT)

Correspondence Address: ARMSTRONG, WESTERMAN & HATTORI, LLP, Suite 220, 502 Washington Avenue, Towson, MD, 21204, US

(73) Assignee: OFFICINE MECCANICHE GALLETTI O.M.G. S.R.L.

(21) Appl. No.: 10/270,834

(22) Filed: Oct. 11, 2002

(30) Foreign Application Priority Data
Oct. 15, 2001 (IT) MC2001U000044

(51) Int. Cl. B28C 5/08

(52) U.S. Cl. 366/67

(57) ABSTRACT

The present invention relates to a support arm for a blade-holding plate used in mixers for concrete, mortar and similar materials, provided with light, inexpensive metal structure obtained with oxygen lance cutting technique and capable of ensuring rapid and fast adjustment of blade-holding plate incidence with respect to the internal vertical walls of the mixer tank.

The present patent application relates to a support arm for a blade-holding plate used in mixers for concrete, mortar and similar materials.

The invention has been devised to optimise a very popular technology used for the realisation of automatic mixers for concrete, mortar and other building materials.

Traditional mixers are composed of a large circular tank that contains the mix ingredients, in which two sets of three basically vertical rotary mixing arms operate, whose lower part is provided with blades used to continuously mix the mass contained in the tank until the different ingredients are completely blended.

Each set of three mixing arms is hung to a rotary bearing plate, which is in turn coupled to the shaft of a crown wheel dragged into rotation by means of a reduction gear mounted on the machine top.

According to this traditional technology two basically horizontally radial arms are applied on the external border of the crown wheel, whose ends are designed to support vertical rods. In turn, each vertical rod supports a pair of scraping blades that rotate together with the crown wheel and remove mix deposits from the internal walls of the mixing tank.

The first blade is a sort of vertical blade designed to interfere with a central section of the internal vertical walls of the tank during rotation. The second blade, which is mounted at the base of the bearing rod, has a basically L-shaped profile that allows it to temporarily interfere with a wide lower section of the vertical walls of the mixing tank and with the external perimeter of the tank bottom.

During the continuous vigorous interference between the internal wall of the mixing tank and the scraping blades, the vertical border of the blades is subject to rapid wear, capable of creating a space between the blades and the vertical wall of the tank over time.

In such a case the scraping effect of the blades is seriously impaired.

For this reason the vertical rod that supports the scraping blades can rotate with respect to the bearing arm.

Of course, rotation must be in the same direction as the vertical wall of the tank to restore the necessary inference between the wall and the external vertical border of the scraping blades.

The need for “adjusting” the interference of the scraping blades with the wall of the mixing tank has determined the presence of a non-rigid connection between the bearing radial arms and the blade-holding rod.

According to the most popular solution, the bearing arm ends with a semicircular sleeve (a jaw) in which the upper end of the blade-holding tubular rod is engaged. The rod is then blocked by means of a second semicircular jaw tightened with the first fixed jaw with bolts with horizontal axis.

It appears evident that the fixing of the rod to the bearing radial arm is quite complex. This operation is additionally complicated by the fact that it requires the presence of a special anti-rotation cover to prevent the rod from rotating accidentally around its own axis inside the two fixing jaws because of the resistance encountered by the blades during mixing due to the presence of lumps in the mix or to the undesired interference with the tank.

In particular, the operation needed to rigidly fix the blade-holding rod to the bearing arm is extremely difficult since it is often necessary to vary the incidence angle of the blade-holding rod with respect to the vertical wall of the mixing tank.

To do this, the anti-rotation cover must be removed, the two jaws that tighten the blade-holding tubular rod must be loosened, the rod incidence must be adjusted, and the two jaws together with the anti-rotation cover must be replace.

The long articulated sequence of operations necessary for blade-holding rod “adjustment” represents the first significant drawback of the traditional technology illustrated above. This technology is additionally impaired by the construction of the bearing arms that are radially fixed to the crown wheel of the mixer.

Radial arms today normally have a big, sophisticated and expensive structure: it is a composite structure resulting from the assembly of different segments, in with each segment is subjected to preliminary operations.

The specific purpose of the invention is to eliminate the above disadvantages that are typical of the traditional technology as illustrated above.

Firstly, the arm of the invention has been provided with a smaller, lighter and cheaper structure compared to existing arms. Secondly, the invention provides for the connection between the arm and a special vertical blade-holding plate that ensures the rapid easy adjustment of the incidence of the plate with respect to the internal walls of the mixing tank.

The first objective has been achieved by realising the arm with oxygen lance cutting technique (or casting) from a plate. This operation ensures excellent quality at very low cost compared to the cost of the complicated operations that are currently needed to produce traditional arms with composite structure.

The second objective has been achieved by providing the front parallelepiped end of the arm with two through slots with vertical axis.

Once the top section (or “head”) of the blade-holding plate touches the lower side of the front end of the bearing arm, two bolts are inserted from up down through the slots located on the front parallelepiped end of the arm.

The bolts engage in threaded holes with vertical axis located on the head of the blade-holding plate. Once tightened, the bolts ensure the stable connection of the blade-holding plate with the bearing arm.

In this way, the adjustment of the incidence angle of the blade-holding plate with respect to the lateral wall of the tank can be easily and rapidly carried out by loosening the two tightening bolts, adjust the blade-holding plate as desired and fasten the two bolts again.

The adjustment of the blade-holding plate with respect to the bearing arm of the invention can be carried out without having to disassemble the two elements, thanks to the fact that, once loosened, the tightening bolts can move inside the slots located at the end of the arm.

For major clarity the description of invention continues with reference to the enclosed drawings, which are intended for purposes of illustration and not in a limiting sense, whereby:

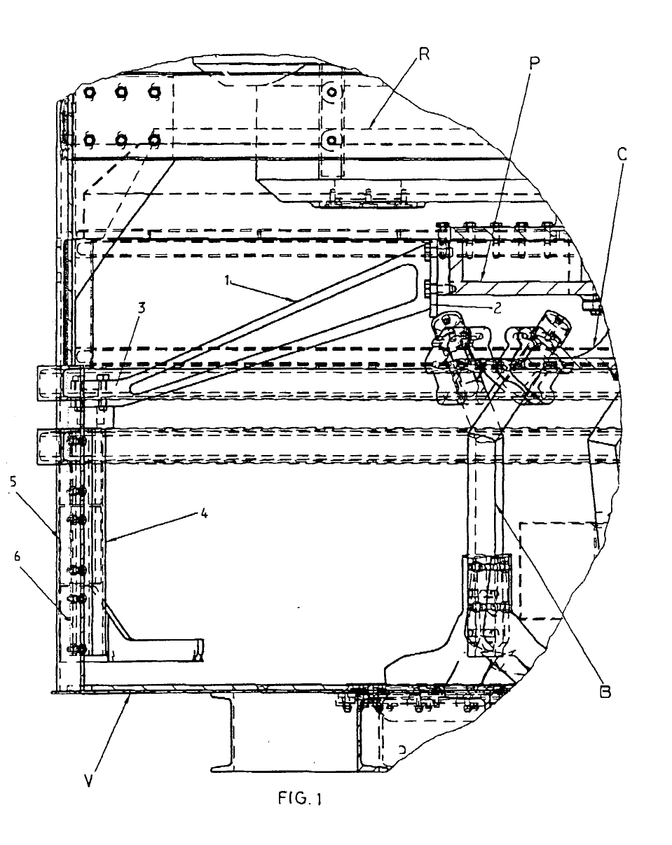

FIG. 1 is a lateral diagrammatic view of a mixer in which a section of the vertical wall has been removed to show the internal structure;

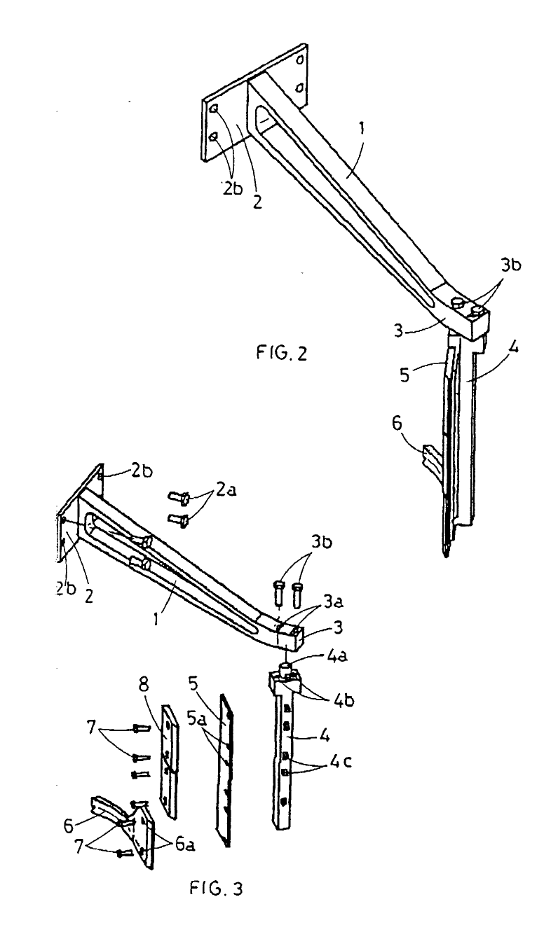

FIG. 2 is an axonometric view of the arm of the invention coupled with the blade-holding plate;

FIG. 3 is the exploded view of FIG. 2.

With reference to FIG. 1, the arm (1) of the invention operates in the tank (V) of a mixer for concrete, mortar and similar materials, of the type provided with a reduction gear (R) that actuates a crown wheel (P), which in turns drags into rotation two crosses (C) that support two sets of three mixing arms (B).

In particular the arm (1) is radially fixed against the border of the crown wheel (P) by means of a suitable bracket (2) placed edgeways and welded at the rear end. Fixing is obtained by means of suitable bolts (2) capable of being screwed into the crown wheel (P) after passing through the through holes (2b) located on the bracket (2) of the arm (1).

As mentioned above, the arm (1) is obtained with oxygen lance cutting technique (or casting) and has a basically triangular shape with a large central lightening cut. The front end (3) of the arm (1) has a basically parallelepiped shape and features two opposite through slots (3a) with vertical axis, preferably with semicircular profile.

The front end (3) is also used to fix a blade-holding plate (4) in vertical position.

The plate (4) has a basically T-shaped head, from which a pin (4a) centrally protrudes. Two threaded holes (4b) with vertical axis are located near the pin. The pin (4a) engages in a corresponding cavity (not shown in the enclosed figures) realised on the lower side of the front end (3) of the arm (1), while the two holes (4b) are capable of perfectly aligning with the slots (3a) of the front end (3) of the arm (1).

The two parts (1, 4) are steadily fixed by means of suitable bolts (3b) with vertical axis, which are inserted in the slots (3a) from up downwards and engage with the threaded holes (4b) of the blade-holding plate (4). Before tightening, the bolts (3b) and the blade-holding plate (4) can be moved with respect to the front end (3) of the arm (1) thanks to the presence of the slots (3a).

In the preferred version shown in the aforementioned figures, the blade-holding plate (4) obtained with oxygen lance cutting technique consists in a rod with quadrilateral cross-section, whose front end houses holes (4c) with horizontal axis used to fix two scraping blades (5, 6) with basically traditional structure, of which the upper blade (5) is composed of a sort of vertical blade and the lower blade (6) is fixed to the base of the blade (4) and is of scroll-shaped type.

The two scraping blades (5, 6) are fixed to the bearing plate (4) by means of bolts (7) with horizontal axis that are introduced into the through holes (5a, 6a) and engage in the holes (4c) of the plate (4).

Number (8) identifies a counter-plate with slots (8a) designed to engage with the front side of the vertical blade (5) to allow for adjusting the fixing position with respect to the support plate (4).

1. A support arm for a blade-holding plate used in mixers for concrete, mortar and similar materials, characterised in that its metal structure is obtained with oxygen lance cutting technique and provided with basically triangular shape with a large central lightening cut; it being provided that the arm (1), which is provided with a fixing bracket (2) placed edgeways and equipped with through holes (2b) with horizontal axis, has a basically parallelepiped front end (3) with two through slots (2b) with vertical axis for the up-down passage and transversal movement of bolts (3b) designed to engage into threaded holes (4b) vertically made on the top section of a blade-holding plate (4) obtained with oxygen lance cutting technique in contact with the lower side of the front end (3) of the arm (1).

2. A support arm according to claim 1, characterised in that the front end (3) has a basically cylindrical cavity capable of housing a vertical pin (4a) that protrudes from the centre of the top section of the blade-holding plate (4), featuring a regular series of through holes with horizontal axis (4c) on the entire height used to fix two traditional scraping blades (5, 6) with holes with horizontal axis (5a, 6a) by means of bolts (7).
